(19) United States
(12) Patent Application Publication
(10) Pub. No.: US 2004/0156957 A1
(43) Pub. Date: Aug. 12, 2004

(54) Oil and moisture absorbent material and food package

(76) Inventors: Sandeep Kulkarni, Morrow, OH (US); Ladislav Bednarik, Loveland, OH (US); Keith S. Shih, Loveland, OH (US); Richard Previty, Milford, OH (US); I. Daniel Sand, Loveland, OH (US); Vivek Rohatgi, Loveland, OH (US); Richard A. Tedford JR., Loveland, OH (US); John Tonelli, Batavia, OH (US)

Correspondence Address: OSTRAGER CHONG & FLAHERTY LLP, 825 THIRD AVE, 30TH FLOOR, NEW YORK, NY, 10022-7519, US

(21) Appl. No.: 10/365,303

(22) Filed: Feb. 12, 2003

(51) Int. Cl. A23B 4/00

(52) U.S. Cl. 426/127

(57) ABSTRACT

A oil and moisture absorbent material suitable for use in food packages and a food package made of such material. The material comprises an oil and moisture absorbent layer covered by an oil and moisture repellent substance that has a multiplicity of perforations or which is applied in a pattern so that oil and moisture can pass through. Alternatively, the oil and moisture absorbent layer may be covered by an oil and moisture permeable substance. The oil and moisture absorbent layer may have indentations and additives that improve its oil and moisture absorbency. The oil and moisture absorbent layer may be made of a paperboard that is manufactured using a reduced level of calendering and having a reduced amount of sizing applied.

### FIELD OF INVENTION

This invention generally relates to an oil and moisture absorbent material and, more particularly, to an improved food package having portions made of an oil and moisture absorbent material.

### BACKGROUND OF INVENTION

In the packaging of freshly prepared hot foods for on-the-go situations (e.g. fast food dining, takeout) it is important that the package containing the hot food (“food package”) maintain the quality of the food prior to consumption in addition to simply acting as a carrier for the food. Typically, in hot, greasy foods such as fried chicken, the oil and moisture accumulates in the package, causing sogginess of the food and deterioration of the food quality. The term “oil” as used herein includes oil and/or grease coming from the food itself as well as oil and/or grease used to cook the food. The term “moisture” as used herein includes water, water vapor (e.g. steam), condensed water vapor, juices extruded by the food and liquids used in cooking (e.g. vinegar, soy sauce).

Packages presently used to contain hot food having significant amounts of oil and moisture are constructed from paperboard that is made to resist penetration by oil (“oil repellent”) and/or resist penetration by moisture (“moisture repellent”) as well. This resistance to penetration is accomplished by sizing or coating the paperboard with agents that prevent said penetration. Thus, the oil and moisture are retained within the package. However, the oil and moisture remain in contact with the food and contact of the food with oil and moisture decreases the flavor, perceived mouth-feel and overall presentation of the food.

Currently, most of the available technologies for absorbing oil and/or moisture are based on an oil and/or moisture absorbent pad. See e.g. U.S. Pat. No. 5,552,169 to Kannankeril et al., U.S. Pat. No. 5,814,396 to Weldner, U.S. Pat. No. 5,096,722 to Bair and U.S. Pat. No. 5,041,325 to Larson et al. Absorbent pads may be made from an absorbent foam, absorbent non-woven material, superabsorbent polymers, cellulosic fibers or fluff pulp or combinations of these materials.

A major disadvantage in using absorbent pads in food packages is the need to insert such a pad into the package before filling the package with food. This creates an added operation on the part of food service personnel, as well as a need to maintain a separate inventory of the absorbent pads in the restaurant or other food service establishment. Further, the presence of an absorbent pad in the food package is aesthetically unpleasant for some customers. It is possible to avoid the foregoing disadvantage by incorporating an absorbent pad into the package itself as a form of liner during the food package manufacturing process. See, e.g. U.S. Pat. No. 4,984,907 to Power. However, such an arrangement creates significant complexity as well as added cost to the manufacturing process.

For the foregoing reasons, there is a need for a food package that will absorb oil and moisture but which does not require placing a separate absorbent pad into the package before filling the package with food or require incorporating an absorbent pad into the food package during the manufacture of the food package.

### SUMMARY OF INVENTION

In the present invention, the foregoing purposes, as well as others that will be apparent, are achieved using an oil and moisture absorbent material as part of the food package itself. The food package is comprised of a body portion and a bottom portion. The body portion is formed from a suitable material such as paperboard. The body portion may be oil and/or moisture repellent. The bottom portion is comprised of an oil and moisture absorbent substance which is covered by an oil and water repellent layer having a multiplicity of perforations that allow oil and moisture to pass through.

The advantage of the present invention is that the oil and moisture absorbency is incorporated into the material of the food package itself and is integral to the package. Since no absorbent pad or liner needs to be introduced, this food package construction is indistinguishable from a standard food package both to food service operators as well as to the final customer. Further, the manufacture of the food package described above does not require any significant change to existing manufacturing processes.

### BRIEF DESCRIPTION OF DRAWINGS

FIG. 1 is a front plan view of a food package embodying features of the present invention.

FIG. 2 is cross-section of a side view of the bottom portion of a food package embodying features of the present invention.

FIG. 3 is a cross-section of a side view of the bottom portion of another food package embodying features of the present invention.

FIG. 4 is cross-section plan view of a food package comprised of the bottom portion shown in FIG. 2.

FIG. 5 is a cross-section plan view of another food package embodying features of the present invention.

FIG. 6 is a cross-section plan view of another food package embodying features of the present invention.

### DESCRIPTION OF PREFERRED EMBODIMENTS

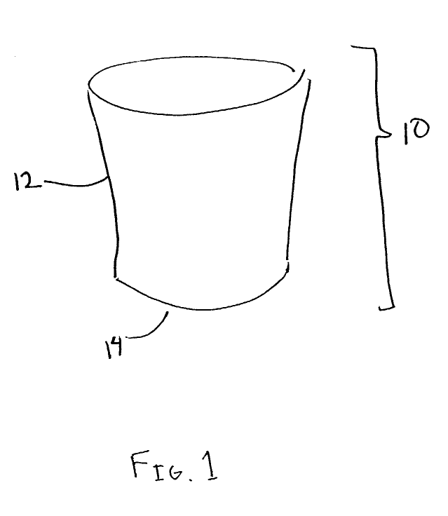

As shown in FIG. 1, a food package 10 in accordance with one embodiment of the present invention generally comprises a body portion 12 and a bottom portion 14. The food package may have a cover or lid (not shown) to protect the food from contaminants and to keep the food warm.

A food package of this invention may be prepared by cutting a body portion blank from a suitable material (described below), cutting a bottom portion blank from a suitable material (described below) and attaching the body portion blank to the bottom portion blank by conventional means such as adhesives, crimping, heat sealing, or sonic welding, preferably heat sealing.

The body portion 12 may be made from any material suitable for use in a food package such as such paper, paperboard, or synthetic materials, preferably paperboard. The interior surface of the body portion (i.e. the surface in contact with food) may be coated with an oil and/or moisture repellent material such as wax, plastic or polymer. Alternatively, the body portion 12 can be made from the same material as the bottom portion 14 and thereby achieving the same benefits (described below).

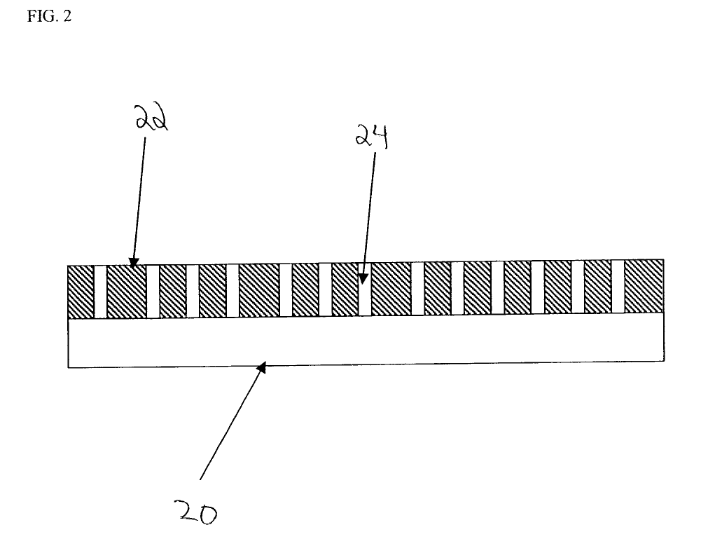

As shown in FIG. 2, the bottom portion 14 comprises a first layer 20 and a second layer 22 on top of and covering the first layer. The first layer 20 may be made from any oil and moisture absorbent material suitable for use in a food package such as paper, paperboard or synthetic material, preferably paperboard. Also, the first layer may comprise only a single layer such as a single ply paperboard or the first layer may comprise multiple layers (i.e. sublayers) such as multi-ply paperboard (not shown). In one embodiment, the first layer 20 is made from paperboard manufactured on a paper machine using a reduced level of calendering and having a reduced amount of sizing applied because it has been found that a reduced level of calendering and a reduced amount of sizing applied during paperboard manufacture process increases the absorbency of the paperboard. As used herein, the term “absorbency” includes the rate of absorption and/or amount of oil or moisture being absorbed. Preferably, the reduced level of calendering and the reduced amount of sizing produces a paperboard having a density of not greater than about 7 g/cm³ and a Hercules Sizing Test (HST) value of less than about 350 seconds. Nevertheless, even though the foregoing paperboard is preferred, it is not required that this type of paperboard be used in the food package.

The absorbency of the paperboard used to form the first layer may be enhanced by incorporating additives that absorb or adsorb oil and/or moisture into the paperboard. Examples of oil absorbing additives are absorbent cellulosic fibers or activated carbon. Examples of oil adsorbing additives are molecular sieves or hydrophobically modified silica gel. Examples of moisture absorbing additives are humectants (e.g. sodium nitrate or sodium sulfate), absorbent cellulose fibers or microcrystalline cellulose. Examples of moisture adsorbing additives are silica gels or molecular sieves. The foregoing additives may be added during manufacturing of the paperboard and/or applied to the surface of the paperboard.

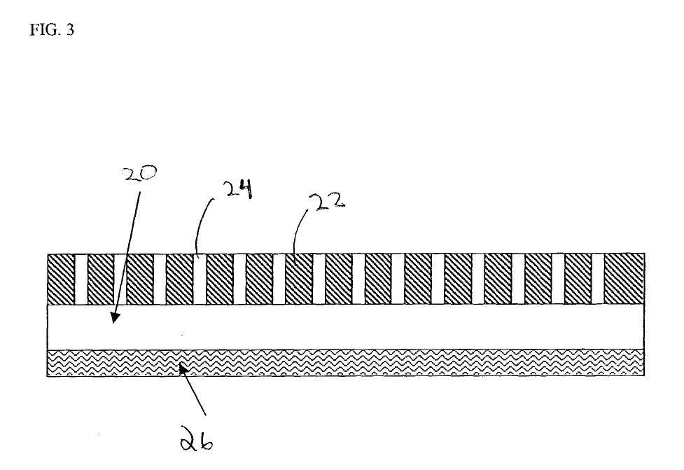

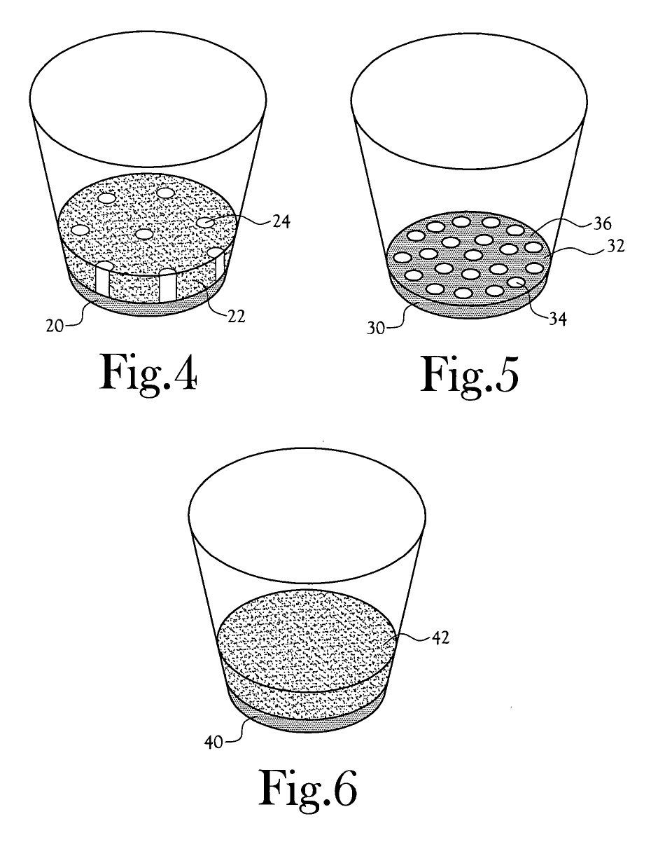

As shown in FIG. 2, the top surface (i.e. the inner surface or surface nearer to or in contact with the food) of the first layer 20 is covered by an oil and moisture repellent second layer 22 having a multiplicity of perforations 24 to allow oil and moisture from the food to pass through second layer 22 to the first layer 20. The second layer 22 minimizes contact between the food and the oil and moisture absorbed by the first layer 20, thereby preserving the appearance and quality of the food. As shown in FIG. 3, the bottom surface (i.e. the outer surface or surface further away from or not in contact with the food) of the first layer 20 may be covered with a non-perforated, oil and moisture repellent protective layer 26 to prevent oil and moisture from escaping (i.e. leaking) from the first layer 20. However, although a protective layer 26 is preferred, the bottom surface of the first layer 20 is not required to have a protective layer 26.

In the preferred embodiment, the second layer 22 is a polymer film. The polymer film is formed by using an extrusion-coating process to apply a polymer to a paperboard comprising the first layer. The polymer is applied to the paperboard before the bottom portion blank is cut from the paperboard or, alternatively, the polymer is applied to the bottom blank before the food package is assembled. Examples of suitable polymers are linear low density polyethylene, high density polyethylene, polypropylene, copolymers of ethylene, copolymers of propylene and blends of these polymers; a preferred polymer is low density polyethylene (LDPE). Additives such as calcium carbonate (CaCO₃) may be added to the polymer in order to facilitate the perforation process (described below). After the polymer film has been applied to paperboard or bottom portion blank, the polymer film is perforated by passing the paperboard or bottom portion blank against a mechanical perforating device such as a microperforating roll (i.e. machine roller with needles on its surface). Alternatively, the polymer film can be perforated using other means such as by compression against a grit roll, compression against a knurled roll or by subjecting the paperboard or bottom portion blank to corona or flame treatment that creates pinholes in the polymer film.

Also, the penetration of oil and moisture through the perforations 24 and into the first layer 20 may be enhanced by incorporating a “waffle pattern” or indentations (not shown) in the structure of the first layer. The waffle pattern or indentations assist in channeling of oil and moisture into the perforations, thereby increasing the oil and moisture absorbency of the paperboard. The waffle pattern or indentations can be produced by an embossing the paperboard after the polymer film has been perforated but before the food package is assembled.

Alternatively, instead of the polymer film described above, an oil and moisture repellent coating may be applied to the paperboard. The oil and moisture repellent coating may be aqueous or non-aqueous, preferably aqueous. An example of a class of aqueous materials suitable for use as oil and moisture repellent coating are emulsified acrylic-containing polymers such as Spectraguard HSL™ which is available from Spectrakote Inc. The forgoing aqueous materials may be used singly or as blends of such materials. As shown in FIG. 5, the coating 32 is applied to the paperboard 30 in a pattern so that the open (i.e. uncoated) portions 34 of the paperboard between the coated areas 36 allow penetration of oil and moisture into the paperboard 30 without need for any perforations. The coating is applied to the paperboard using a flexographic printing process.

In another alternative, instead of the polymer film described above, an oil and moisture permeable coating 42 may be applied as a uniform coating to the paperboard 40. (See, FIG. 6) The oil and moisture permeable coating may be aqueous or non-aqueous, preferably aqueous. Examples of aqueous materials suitable for use as oil and moisture permeable coatings are Nucoat 8329™ which is available from Nucoat Inc. and emulsified vinyl chloride-containing polymers which are available from Air Products. The forgoing aqueous materials may be used singly or in blends of such materials. The coating may be applied to the paperboard using a rod coating process, blade coating process, air-knife coating process, spray coating process, curtain coating process or a gravure printing process. The oil and moisture permeable coating allows the oil and moisture to pass through the second layer to the first layer without the need for perforations.

In another alternative embodiment, instead of the polymer film or coatings described above, an olefinic polymer that is formulated to have a high intrinsic absorptivity for oil and moisture (hereafter referred to as a “formulated olefinic polymer”) is used to form either a film or an open celled foam structure on the surface of the paperboard. Since the formulated olefinic polymer has a high intrinsic absorptivity for oil and moisture, perforations (described above) in the film or foam structure are not required. Examples of suitable formulated olefinic polymers are Hisorb™ polymers supplied by Hitech Polymers, blends of said Hisorb™ polymers, blends of Hisorb™ polymers with other polymers (described above) such as LDPE. In this alternative embodiment, the oil and moisture is absorbed by the film or foam structure as well as the paperboard, resulting in high amount of total oil and moisture absorption. In the case of the film, although it is not required, the film may be perforated (using the perforation methods described above) to increase oil and moisture absorbency of the film and/or the paperboard. The film or the foam structure can applied to the paperboard by an extrusion coating, adhesive-lamination or an ultrasonic welding, preferably extrusion coating.

The following examples are provided to further illustrate the present invention but are in no way to be taken as limiting.

### EXAMPLE 1

A paperboard with density of less than about 7 g/cm³ and HST of less than about 350 seconds, was prepared by reducing the level of sizing as well as the level of calendering on a standard 18 mil. thickness bleached paperboard. The paperboard was found to have oil absorption, as measured by 2-min. cobb values, in the range of 200-225 g/m²

### EXAMPLE 2

The paperboard in Example 1 was extrusion coated with 0.5 mil. thick layer of low density polyethylene on one side to form a polymer film. The polymer film was perforated by rolling a perforating roller on the surface of the film, using hand pressure. The opposite side of the paperboard was then extrusion coated with a 0.5 mil. thick layer of low density polyethylene. The oil absorption, as measured by 2-min. cobb values, was tested on the perforated side and was found to be in the range of 180-200 g/m²

### EXAMPLE 3

One side of the paperboard in Example 1 was extrusion coated with 0.5 mil. thick layer of a 75/25 blend of low density polyethylene and high density polyethylene. The other side of the paperboard was extrusion coated with 0.5 mil. thick layer of low density polyethylene. The paperboard was then run through a nip between two rubber rolls where the surface of one of the rubber rolls was covered with a sandpaper. The paperboard was introduced into the nip such that the side of the paperboard coated with the polymer blend, was in contact with the sandpaper. The sandpaper was found to create fine perforations in the polymer blend film, as verified by rubbing a red dye on the surface of the film and observing penetration of the dye into the paperboard. The oil absorption, as measured by 2-min. cobb values, was tested on the perforated side and was found to be in the range of 200-225 g/m².

### EXAMPLE 4

One side of the paperboard in Example 1 was coated with 1.5 lbs./3000 ft² of Nucoat 8329™ aqueous coating. The other side of the paperboard was extrusion coated with 0.5 mil. thick layer of low density polyethylene. The aqueous coating was applied to the paperboard using a priming roll on an extrusion equipment. The side of the paperboard with the aqueous coating was tested for oil absorption, as measured by 2-min. cobb values, and was found to have cobb values in the range of 200-210 g/m²

### EXAMPLE5

One side of the paperboard in Example 1 was coated with 1.5 lbs./3000 ft² of Spectraguard HSL™ aqueous coating. The coating was applied to the paperboard using a flexographic printing process, as a dot pattern at 50% coverage of the paperboard. The other side of the paperboard was extrusion coated with 0.5 mil. thick layer of low density polyethylene. The side of the paperboard with the aqueous coating was tested for oil absorption, as measured by 2-min. cobb values, and was found to have cobb values in the range of 190-200 g/m²

### EXAMPLE 6

The paperboard in Example 4 was used to form the bottom of a bucket for packaging fried chicken. Standard paperboard, 18 mil. in thickness and having 0.5 mil thick low density polyethylene coating on both sides, was used to form the side walls of the bucket. The bucket was made on a standard bucket forming machine. The bucket was filled with freshly fried chicken and the bottom of the bucket was seen to absorb a large amount of oil and moisture over a four hour period. The bucket bottom showed minimal sagging or bowing, under normal conditions of filling of chicken and storage, over a four hour period. The bucket, containing ten pieces of chicken, was dropped from a height of approximately six feet and did not show any signs of burst or loss of mechanical integrity.

### EXAMPLE 7

The paperboard in Example 5 was used to form the bottom of a bucket for packaging fried chicken. Standard paperboard, 18 mil. in thickness and having 0.5 mil thick low density polyethylene coating on both sides, was used to form the side walls of the bucket. The bucket was made on a standard bucket forming machine. The bucket was filled with freshly fried chicken and the bottom of the bucket was seen to absorb a large amount of oil and moisture over a four hour period. The bucket bottom showed minimal sagging or bowing, under normal conditions of filling of chicken and storage, over a four hour period. The bucket, containing ten pieces of chicken, was dropped from a height of approximately six feet, and did not show any signs of burst or loss of mechanical integrity.

Although the invention has been described with reference to preferred embodiments, it will be appreciated by one of ordinary skill in the art that numerous modifications are possible in light of the above disclosure. For example, in the preferred embodiment the food package is bucket shaped. However, the preferred materials incorporating concepts of this invention may be used in other food package configurations, e.g. box or rectangular shapes, clamshell (e.g. containers for hamburgers) or portions of a food package. Also, the food packages may have a unitary construction rather than a separate body and bottom portion (e.g. packages cut out of and assembled from a single sheet of paperboard by means of folding). Further, the food package may have bottom portion that is comprised only of the first layer (i.e. the oil and moisture absorbent material). All such variations and modifications are intended to be within the scope and spirit of the invention.

What is claimed is:

1. A material suitable for use in food packages, the material comprising:
a first layer comprising an oil and moisture absorbent substance and
a second layer covering a top surface of the first layer, the second layer comprising an oil and moisture repellent substance having a multiplicity of perforations to allow oil and moisture to pass through the second layer.

2. The material of claim 1, wherein the first layer comprises a multiplicity of sublayers.

3. The material of claim 1, further comprising a third layer covering a bottom surface of the first layer, the third layer comprising an oil and moisture repellent substance.

4. The material of claim 1, wherein the oil and moisture absorbent substance is paperboard.

5. The material of claim 4, wherein the paperboard has a density of not greater than about 7 g/cm³.

6. The material of claim 4, wherein the paperboard has a Hercules Sizing Test value of not more than about 350 seconds.

7. The material of claim 4, wherein the paperboard contains an additive to increase the oil absorbency of the paperboard.

8. The material of claim 4, wherein the paperboard contains an additive to increase the moisture absorbency of the paperboard.

9. The material of claim 4, wherein the paperboard has indentations to increase the oil and moisture absorbency of the paperboard.

10. The material of claim 1, wherein the second layer is a polymer film.

11. The material of claim 10, wherein the polymer comprises a blend of polymers.

12. The material of claim 10, wherein the polymer comprises a low density polyethylene.

13. The material of claim 1 wherein the multiplicity of perforations is created using a knurled roll.

14. A material suitable for use in food packages, the material comprising:
a first layer comprising an oil and moisture absorbent substance and
a second layer comprising an oil and moisture repellent substance, the second layer covering a first region of a top surface of the first layer while not covering a second region of the top surface of the first layer so that oil and moisture can pass through the second region to the first layer.

15. The material of claim 14, wherein the first layer comprises a multiplicity of sublayers.

16. The material of claim 14, further comprising a third layer covering a bottom surface of the first layer, the third layer comprising an oil and moisture repellent substance.

17. The material of claim 14, wherein the oil and moisture absorbent substance is paperboard.

18. The material of claim 17 wherein the paperboard has a density of not greater than about 7 g/cm³.

19. The material of claim 17 wherein the paperboard has a Hercules Sizing Test value of less than about 350 seconds.

20. The material of claim 17, wherein the paperboard contains an additive to increase the oil absorbency of the paperboard.

21. The material of claim 17, wherein the paperboard contains an additive to increase the moisture absorbency of the paperboard.

22. The material of claim 17, wherein the paperboard has indentations to increase the oil and moisture absorbency of the paperboard.

23. The material of claim 14, wherein the oil and moisture repellent substance comprises an aqueous coating.

24. The material of claim 23, wherein the aqueous coating comprises an emulsified acrylic-containing polymer.

25. A material suitable for use in food packages, the material comprising:
a first layer comprising an oil and moisture absorbent substance and
a second layer covering a top surface of the first layer, the second layer comprising an oil and moisture permeable substance.

26. The material of claim 25, wherein the first layer comprises a multiplicity of sublayers.

27. The material of claim 25, further comprising a third layer covering a bottom surface of the first layer, the third layer comprising an oil and moisture repellent substance.

28. The material of claim 25, wherein the oil and moisture absorbent substance is paperboard.

29. The material of claim 28 wherein the paperboard has a density of not greater than about 7 g/cm³.

30. The material of claim 28 wherein the paperboard has a Hercules Sizing Test value of less than about 350 seconds.

31. The material of claim 28, wherein the paperboard contains an additive to increase the moisture absorbency of the paperboard.

32. The material of claim 28, wherein the paperboard contains an additive to increase the oil absorbency of the paperboard.

33. The material of claim 28, wherein the paperboard has indentations to increase the oil and moisture absorbency of the paperboard.

34. The material of claim 25, wherein the oil and moisture permeable substance comprises an aqueous coating.

35. The material of claim 34, wherein the aqueous coating comprises an emulsified vinyl chloride-containing polymer.

36. A material suitable for use in food packages, the material comprising:
a first layer comprising an oil and moisture absorbent substance and
a second layer covering a top surface of the first layer, the second layer comprising a formulated olefinic polymer.

37. The material of claim 36, wherein the first layer comprises a multiplicity of sublayers.

38. The material of claim 36, further comprising a third layer covering a bottom surface of the first layer, the third layer comprising an oil and moisture repellent substance.

39. The material of claim 36, wherein the oil and moisture absorbent substance is paperboard.

40. The material of claim 39, wherein the paperboard has a density of not greater than about 7 g/cm³.

41. The material of claim 39, wherein the paperboard has a Hercules Sizing Test value of not more than about 350 seconds.

42. The material of claim 39, wherein the paperboard contains an additive to increase the oil absorbency of the paperboard.

43. The material of claim 39, wherein the paperboard contains an additive to increase the moisture absorbency of the paperboard.

44. The material of claim 39, wherein the paperboard has indentations to increase the oil and moisture absorbency of the paperboard.

45. The material of claim 36, wherein the second layer comprises a film.

46. The material of claim 36, wherein the second layer comprises an open celled foam structure.

47. The material of claim 36, wherein the formulated olefinic polymer comprises a blend of formulated olefinic polymers.

48. The material of claim 36, wherein the formulated olefinic polymer is blended with a low density polyethylene.

49. A food package comprising:
a body portion and
a bottom portion having:
a first layer comprising an oil and moisture absorbent substance and
a second layer covering a top surface of the first layer, the second layer comprising an oil and moisture repellent substance having a multiplicity of perforations to allow oil and moisture to pass from the second layer to the first layer.

50. The food package of claim 49, wherein the first layer comprises a multiplicity of sublayers.

51. The food package of claim 49, further comprising a third layer covering a bottom surface of the first layer, the third layer comprising an oil and moisture repellent substance.

52. The food package of claim 49, wherein the first layer is paperboard.

53. The food package of claim 52, wherein the paperboard has a density of not greater than about 7 g/cm³.

54. The food package of claim 52, wherein the paperboard has a Hercules Sizing Test value of less than about 350 seconds.

55. The food package of claim 52, wherein the paperboard contains an additive to increase the oil absorbency of the paperboard.

56. The food package of claim 52, wherein the paperboard contains an additive to increase the moisture absorbency of the paperboard.

57. The food package of claim 52, wherein the paperboard has indentations to increase the oil and moisture absorbency of the paperboard.

58. The food package of claim 49, wherein the second layer is a polymer film

59. The food package of claim 58, wherein the polymer comprises a blend of polymers.

60. The food package of claim 58, wherein the polymer is a low density polyethylene.

61. The food package of claim 49, wherein the multiplicity of perforations is created using a knurled roll.

62. A food package comprising:
a body portion and
a bottom portion having:
a first layer comprising an oil and moisture absorbent substance and
a second layer comprising an oil and moisture repellent substance, the second layer covering a first region of a top surface of the first layer while not covering a second region of the top surface of the first layer so that oil and moisture can pass through the second region to the first layer.

63. The food package of claim 62, wherein the first layer comprises a multiplicity of sublayers.

64. The food package of claim 62, further comprising a third layer covering a bottom surface of the first layer, the third layer comprising an oil and moisture repellent substance.

65. The food package of claim 62, wherein the oil and moisture absorbent substance is paperboard.

66. The food package of claim 65, wherein the paperboard has a density of not greater than about 7 g/cm³.

67. The food package of claim 65, wherein the oil and moisture absorbent paperboard has a Hercules Sizing Test value of less than about 350 seconds.

68. The food package of claim 65, wherein the paperboard contains an additive to increase the oil absorbency of the paperboard.

69. The food package of claim 65, wherein the paperboard contains an additive to increase the oil absorbency of the paperboard.

70. The food package of claim 65, wherein the paperboard has indentations to increase the oil and moisture absorbency of the paperboard.

71. The food package of claim 62, wherein the oil and moisture repellent substance comprises an aqueous coating.

72. The material of claim 71, wherein the aqueous coating comprises an emulsified acrylic-containing polymer

73. A food package comprising:
a body portion and
a bottom portion having:
a first layer comprising an oil and moisture absorbent substance and
a second layer covering a top surface of the first layer, the second layer comprising an oil and moisture permeable substance.

74. The food package of claim 73, wherein the first layer comprises a multiplicity of sublayers.

75. The food package of claim 73, further comprising a third layer covering a bottom surface of the first layer, the third layer comprising an oil and moisture repellent substance.

76. The food package of claim 73, wherein the oil and moisture absorbent substance is paperboard.

77. The food package of claim 76, wherein the paperboard has a density of not greater than about 7 g/cm³.

78. The food package of claim 76, wherein the paperboard has a Hercules Sizing Test value of less than about 350 seconds.

79. The food package of claim 76, wherein the paperboard contains an additive to increase the oil absorbency of the paperboard.

80. The food package of claim 76, wherein the paperboard contains an additive to increase the moisture absorbency of the paperboard.

81. The food package of claim 76, wherein the paperboard has indentations to increase the moisture absorbency of the paperboard.

82. The material food package of claim 73, wherein the oil and moisture permeable substance comprises an aqueous coating.

83. The material of claim 82, wherein the aqueous coating comprises an emulsified vinyl chloride-containing polymer.

84. A food package comprising:
a body portion and
a bottom portion having:
a first layer comprising an oil and moisture absorbent substance and
a second layer covering a top surface of the first layer, the second layer comprising a formulated olefinic polymer.

85. The food package of claim 84, wherein the first layer comprises a multiplicity of sublayers.

86. The food package of claim 84, further comprising a third layer covering a bottom surface of the first layer, the third layer comprising an oil and moisture repellent substance.

87. The food package of claim 84, wherein the oil and moisture absorbent substance is paperboard.

88. The food package of claim 87, wherein the paperboard has a density of not greater than about 7 g/cm³.

89. The food package of claim 87, wherein the paperboard has a Hercules Sizing Test value of not more than about 350 seconds.

90. The food package of claim 87, wherein the paperboard contains an additive to increase the oil absorbency of the paperboard.

91. The food package of claim 87, wherein the paperboard contains an additive to increase the moisture absorbency of the paperboard.

92. The food package of claim 87, wherein the paperboard has indentations to increase the oil and moisture absorbency of the paperboard.

93. The food package of claim 84, wherein the second layer comprises a film.

94. The food package of claim 84, wherein the second layer comprises an open celled foam structure.

95. The food package of claim 84, wherein the formulated olefinic polymer comprises a blend of formulated olefinic polymers.

96. The food package of claim 84, wherein the formulated olefinic polymer is blended with a low density polyethylene.

97. A food package comprising
a body portion and
a bottom portion having a single layer comprising an oil and moisture absorbent paperboard.

98. The food package of claim 97, wherein the oil and moisture absorbent paperboard has a density of not greater than about 7 g/cm³.

99. The food package of claim 97, wherein the paperboard has a Hercules Sizing Test value of less than about 350 seconds.

100. The food package of claim 97, wherein the paperboard contains an additive to increase the oil absorbency of the paperboard.

101. The food package of claim 97, wherein the paperboard contains an additive to increase the moisture absorbency of the paperboard.

102. The food package of claim 97, wherein the paperboard has indentations to increase the oil and moisture absorbency of the paperboard.

103. A food package comprising an oil and moisture absorbent package material, the package material comprising:
a first layer comprising an oil and moisture absorbent substance and
a second layer covering an inner surface of the first layer, the second layer comprising an oil and moisture repellent substance having a multiplicity of perforations to allow oil and moisture to pass from the second layer to the first layer.

104. The food package of claim 103, wherein the first layer comprises a multiplicity of sublayers.

105. The food package of claim 103, further comprising a third layer covering an outer surface of the first layer, the third layer comprising an oil and moisture repellent substance.

106. The food package of claim 103, wherein the first layer is paperboard.

107. The food package of claim 106, wherein the paperboard has a density of not greater than about 7 g/cm³.

108. The food package of claim 106, wherein the paperboard has a Hercules Sizing Test value of less than about 350 seconds.

109. The food package of claim 106, wherein the paperboard contains an additive to increase the oil absorbency of the paperboard.

110. The food package of claim 106, wherein the paperboard contains an additive to increase the moisture absorbency of the paperboard.

111. The food package of claim 106, wherein the paperboard has indentations to increase the oil and moisture absorbency of the paperboard.

112. The food package of claim 103, wherein the second layer is a polymer film

113. The food package of claim 112, wherein the polymer comprises a blend of polymers.

114. The food package of claim 112, wherein the polymer is a low density polyethylene.

115. The food package of claim 103, wherein the multiplicity of perforations is created using a knurled roll.
